(19) United States
(12) Patent Application Publication
(10) Pub. No.: US 2022/0149409 A1
(43) Pub. Date: May 12, 2022

(54) MEMBRANE ELECTRODE ASSEMBLY AND FUEL CELL

(71) Applicant: Panasonic Intellectual Property Management Co., Ltd., Osaka (JP)

(72) Inventors: Hitoshi ISHIMOTO, HYOGO (JP); Takeshi MINAMIURA, OSAKA (JP); Shinichiro IMURA, HYOGO (JP); Yoshifumi TAGUCHI, OSAKA (JP); Tsutomu KAWASHIMA, NARA (JP)

(21) Appl. No.: 17/599,991

(22) PCT Filed: Mar. 5, 2020
(86) PCT No.: PCT/JP2020/009446

§ 371 Date: Sep. 29, 2021

(30) Foreign Application Priority Data
Mar. 29, 2019 (JP) 2019-067642

(51) Int. Cl. H01M 8/1004; H01M 4/86

(52) U.S. Cl. CPC H01M 8/1004; H01M 2250/20; H01M 2250/10; H01M 4/8673

(57) ABSTRACT

A membrane-electrode assembly includes an electrolyte membrane, a pair of catalyst layers stacked on surfaces of the electrolyte membrane, and a pair of gas diffusion layers stacked on a side opposite to the electrolyte membrane of one of the pair of catalyst layers and on a side opposite to the electrolyte membrane of the other one of the catalyst layers. One of the pair of catalyst layers contains catalyst particles and a first conductive material. One of the pair of gas diffusion layers in contact with the one of the catalyst layers contains a second conductive material. The first conductive material includes a first particulate conductive member and a first fibrous conductive member, and the second conductive material includes a second fibrous conductive member. The content K2 by mass of the second fibrous conductive member is larger than the content K1 by mass of the first fibrous conductive member.

### TECHNICAL FIELD

The present disclosure relates to a membrane-electrode assembly and a fuel cell.

### BACKGROUND ART

A fuel cell includes, for example, a membrane-electrode assembly having an electrolyte membrane and a pair of electrodes sandwiching the electrolyte membrane. The electrodes each include a catalyst layer and a gas diffusion layer, in this order from the electrolyte membrane side.

The gas diffusion layer disclosed in Patent Literature 1 contains a fluorocarbon resin, a boron-modified carbon, and a fibrous carbon, in which the fibrous carbon is contained in an amount of 5 to 50 parts by weight per 100 parts by mass of the boron-modified carbon.

### CITATION LIST

### Patent Literature

[PTL 1] Japanese Laid-Open Patent Publication No. 2007-141783

### SUMMARY OF INVENTION

### Technical Problem

Fuel cells have been increasing widely utilized in various fields in recent years, and they are required to exhibit higher performance

However, with the gas diffusion layer configured as above, the adhesion with the catalyst layer and the water removal are insufficient, and a fuel cell with excellent power generation performance has been difficult to be realized.

### Solution to Problem

One aspect of the present disclosure relates to a membrane-electrode assembly for a fuel cell, the membrane-electrode assembly including: an electrolyte membrane; a pair of catalyst layers stacked respectively on one and the other surfaces of the electrolyte membrane; and a pair of gas diffusion layers stacked respectively on a side opposite to the electrolyte membrane of one of the pair of catalyst layers and on a side opposite to the electrolyte membrane of the other one of the pair of catalyst layers, wherein one of the pair of catalyst layers contains catalyst particles A and a first conductive material, one of the pair of gas diffusion layers which is in contact with the one of the catalyst layers contains a second conductive material, the first conductive material includes a first particulate conductive member and a first fibrous conductive member, the second conductive material includes at least a second fibrous conductive member, and a content K₂ by mass of the second fibrous conductive member in the second conductive material is larger than a content K₁ by mass of the first fibrous conductive member in the first conductive material.

Another aspect of the present disclosure relates to a fuel cell, including the above-described membrane-electrode assembly.

### Advantageous Effects of Invention

According to the present disclosure, the power generation performance of a fuel cell can be improved.

While the novel features of the invention are set forth particularly in the appended claims, the invention, both as to organization and content, will be better understood and appreciated, along with other objects and features thereof, from the following detailed description taken in conjunction with the drawings.

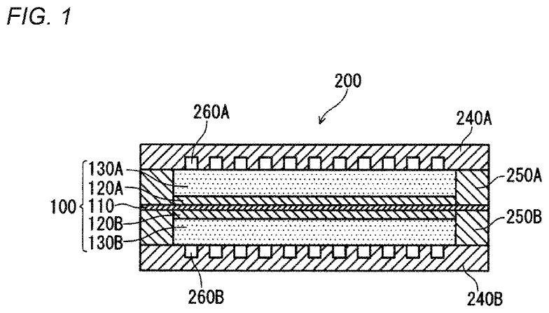

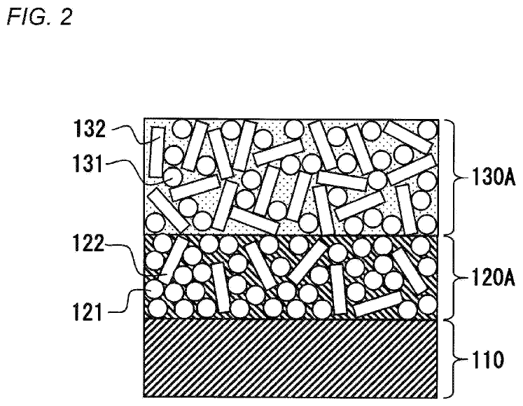

### BRIEF DESCRIPTION OF DRAWINGS

[FIG. 1] A schematic cross-sectional view showing a structure of a unit cell of a fuel cell according to an embodiment of the present disclosure.

[FIG. 2] A schematic diagram showing inside of a first catalyst layer and a first gas diffusion layer constituting part of a membrane-electrode assembly.

### DESCRIPTION OF EMBODIMENTS

A fuel cell according to an embodiment of the present disclosure has a membrane-electrode assembly (hereinafter sometimes referred to as an “MEA”) including an electrolyte membrane, a pair of catalyst layers stacked respectively on one and the other surfaces of the electrolyte membrane, and a pair of gas diffusion layers stacked respectively on a side opposite to the electrolyte membrane of one of the pair of catalyst layers and on a side opposite to the electrolyte membrane of the other one of the pair of catalyst layers. One of the pair of catalyst layers is a cathode catalyst layer included in a cathode, and the other is an anode catalyst layer included in an anode. In the following, one of the pair of gas diffusion layers which is stacked on the anode catalyst layer is referred to as an “anode-side gas diffusion layer” and the other which is stacked on the cathode catalyst layer is referred to as a “cathode-side gas diffusion layer.”

The fuel cell may further include, for example, a cathode separator with electrical conductivity which is in contact with the cathode-side gas diffusion layer, and an anode separator with electrical conductivity which is in contact with the anode-side gas diffusion layer. One unit cell can be configured of an MEA and a pair of separators. By stacking a plurality of cells, with the cathode separator and the anode separator placed adjacent to each other, a stack in which the cells are connected in series can be formed.

One of the pair of catalyst layers contains catalyst particles A and a first conductive material. One of the pair of gas diffusion layers which is in contact with the above one of the catalyst layers contains a second conductive material. The first conductive material includes a first particulate conductive member and a first fibrous conductive member. The second conductive material includes at least a second fibrous conductive member. The second conductive material may further include a second particulate conductive member. The first conductive material and the second conductive material are configured to satisfy the following Condition 1.

### (Condition 1)

The content K₂ by mass of the second fibrous conductive member in the second conductive material is larger than the content K₁ by mass of the first fibrous conductive member in the first conductive material.

In the present embodiment, the catalyst layer and the gas diffusion layer in contact with each other may both contain a particulate conductive member and a fibrous conductive member, as a conductive material. However, the conductive material (second conductive material) contained in the gas diffusion layer may not contain a particulate conductive member (second particulate conductive member) and may be constituted of a fibrous conductive member (second fibrous conductive member) only. The Condition 1 means that, in at least either one of the anode or the cathode, the content K₂ by mass of the second fibrous conductive member which is contained in the gas diffusion layer, in the second conductive material, is larger than the content K₁ by mass of the first fibrous conductive member which is contained in the catalyst layer in contact with the gas diffusion layer, in the first conductive material. By configuring as above, the gas diffusivity can be enhanced. Furthermore, the water generated at the catalyst layer or attached to the catalyst layer can easily pass through the gas diffusion layer and be discharged outside, and a phenomenon where water blocks gas diffusion paths (i.e., flooding) is unlikely to occur.

The first fibrous conductive member and the second fibrous conductive member both may be of the same kind of material, or may at least partially include the same kind of material. Here, that the first fibrous conductive member and the second fibrous conductive member are of the same kind of material means that, starting from raw materials mainly composed of substantially the same materials, they are obtained through substantially the same production processes. For example, when the first fibrous conductive member includes a vapor-grown carbon fiber, the second fibrous conductive member also includes a vapor-grown carbon fiber, or when the first fibrous conductive member includes a carbon nanotube, the second fibrous conductive member also includes a carbon nanotube. In this case, the first fibrous conductive member and the second fibrous conductive member share many common or similar physical properties. Therefore, by making similar to each other the physical properties of the fibrous conductive members contained in the catalyst layer and the gas diffusion layer contacting thereto, the water removal efficiency can be further improved.

However, even when the production processes are substantially the same, the first fibrous conductive member and the second fibrous conductive member may be slightly different from each other in structure, due to impurities contained in the raw materials, or variations in the detailed conditions in the production process, such as the processing temperature or time. For example, the first fibrous conductive member and the second fibrous conductive member may differ in the impurities contained in the fibrous conductive member, the fiber diameter and the fiber length of the fibrous conductive member, the form of the fiber (linear or bent), and the like. In such a case, too, the first fibrous conductive member and the second fibrous conductive member can be referred to as being of the same kind of material.

In view of making the physical properties of the fibrous conductive members similar to each other and thereby improving the water removal efficiency, the ratio of the fiber length of the second fibrous conductive member to the fiber length of the first fibrous conductive member may be in a range of 0.5 to 2.0, regardless of whether or not the first fibrous conductive member and the second fibrous conductive member are of the same kind of material. Here, the fiber length means an average fiber length as defined hereinafter. The above ratio of the fiber length may be in a range of 0.95 to 1.05.

In view of making the physical properties of the fibrous conductive members similar to each other and thereby improving the water removal efficiency, the ratio of the fiber diameter of the second fibrous conductive member to the fiber diameter of the first fibrous conductive member may be in a range of 0.5 to 2.0, regardless of whether or not the first fibrous conductive member and the second fibrous conductive member are of the same kind of material. Here, the fiber diameter means an average fiber diameter as defined hereinafter. The above ratio of the fiber diameter may be in a range of 0.95 to 1.05.

The content K₂ of the second fibrous conductive member in the second conductive material is, for example, 60 mass % or more. The K₂ may be 70 mass % or more, or 80 mass % or more. In contrast, the content K₁ of the first fibrous conductive member in the first conductive material is, for example, 20 to 50 mass %, which is sufficiently small as compared to the K₂.

The upper limit of the content K₂ of the second fibrous conductive member in the second conductive material is not limited, but is, for example, 100 mass % or less, and may be 90 mass % or less.

The content K₂ of the second fibrous conductive member in the second conductive material may be, for example, 60 mass % to 90 mass %.

One of the catalyst layers may constitute a cathode of the fuel cell. That is, the catalyst layer and the gas diffusion layer satisfying the Condition 1 may be a cathode catalyst layer and a cathode-side gas diffusion layer.

In a fuel cell including a proton-conductive polymer electrolyte membrane as an electrolyte membrane, in order to enhance the proton conductivity of the electrolyte membrane, a fuel gas or an oxidizing gas is usually humidified by adding steam thereto, before fed to the catalyst layer. It may occur, however, that part of the steam condenses, and water attaches to the catalyst layer and the gas diffusion layer, to block the gas diffusion paths. Furthermore, water is produced at the cathode during the power generation of the fuel cell. Therefore, on the cathode side, water is more likely to block the gas diffusion paths than on the anode side, and the necessity to remove water is higher.

When the cathode catalyst layer and the cathode-side gas diffusion layer satisfy the Condition 1, more efficient water removal can be achieved. In addition, the produced water is unlikely to block the gas diffusion paths, allowing the gas required for reactions to easily diffuse and reach the catalyst. As a result, the reaction efficiency can be improved and the performance of the fuel cell tends to be enhanced.

In addition to the cathode catalyst layer, the anode catalyst layer may also contain a particulate conductive member and a fibrous conductive member, as a conductive material. In this case, the other one of the pair of catalyst layers contains catalyst particles B and a third conductive material. The third conductive material includes a third particulate conductive member and a third fibrous conductive member.

When the anode catalyst layer contains a third fibrous conductive member, the content K₃ by mass of the third fibrous conductive member in the third conductive material may be almost similar to the content K₁ of the first fibrous conductive member in the cathode catalyst layer. For example, the ratio K₃/K₁ of the content K₃ to the content K₁ may be in a range of 0.5≤K₃/K₁<2.0, and may be in a range of 0.9≤K₃/K₁≤1.1.

When the anode catalyst layer contains a third fibrous conductive member, the content K₂ of the second fibrous conductive member in the cathode-side gas diffusion layer may be larger than the content K₃ by mass of the third fibrous conductive member in the third conductive material. By setting the content of the fibrous conductive member contained in the cathode-side gas diffusion layer to be larger than the content of the fibrous conductive member contained in the anode catalyst layer, the water produced in the cathode catalyst layer can be prevented from excessively diffusing back toward the anode catalyst layer side. Consequently, the diffusion of the produced water into the cathode-side gas diffusion layer and the back diffusion toward the anode catalyst layer side can be appropriately controlled, and the drying of the cathode catalyst layer can be suppressed.

The anode-side gas diffusion layer may be any known gas diffusion layer, and may be, for example, a carbon cloth, a carbon paper, or the like. The anode-side gas diffusion layer can include a conductive material (fourth conductive material), but may or may not include a fibrous conductive member (fourth fibrous conductive member). As described above, on the anode side, the water removal may not be so excellent as that required on the cathode side. Rather, high proton diffusivity is required on the anode side. In view of this, even when the fourth conductive material contains a fourth fibrous conductive member, the content K₄ by mass of the fourth fibrous conductive member in the fourth conductive material may be smaller than the content K₂ of the second fibrous conductive member in the cathode-side gas diffusion layer.

However, in view of enhancing the gas diffusivity at the anode side and improving the water removal under high-humidity operating conditions, the content of the fibrous conductive member in the anode gas diffusion layer may be increased so that the anode catalyst layer and the anode-side gas diffusion layer satisfy the Condition 1.

A combination of the cathode catalyst layer and the cathode-side gas diffusion layer and a combination of the anode catalyst layer and the anode gas-side diffusion layer may both satisfy the Condition 1 above. That is, the gas diffusion layer in contact with the other catalyst layer may include a fourth conductive material. The fourth conductive material includes at least a fourth fibrous conductive member, of a fourth particulate conductive member and the fourth fibrous conductive member. The content by mass of the fourth fibrous conductive member in the fourth conductive material may be larger than the content by mass of the third fibrous conductive member in the third conductive material.

An exemplary structure of a fuel cell according to the present embodiment will be described below with reference to FIG. 1. FIG. 1 is a schematic cross-sectional view showing a structure of a unit cell included in a fuel cell according to one embodiment. Typically, a plurality of unit cells are stacked and included as a cell stack in a fuel cell. In FIG. 1, one unit cell is shown for the sake of convenience.

A unit cell 200 includes a membrane-electrode assembly 100 having: an electrolyte membrane 110; a first catalyst layer 120A and a second catalyst layer 120B disposed so as to sandwich the electrolyte membrane 110; and a first gas diffusion layer 130A and a second gas diffusion layer 130B disposed so as to sandwich the electrolyte membrane 110 with the first catalyst layer 120A and the second catalyst layer 120B respectively interposed therebetween. The unit cell 200 further includes a first separator 240A and a second separator 240B sandwiching the membrane-electrode assembly 100. One of the first catalyst layer 120A and the second catalyst layer 120B functions as an anode, and the other functions as a cathode. The electrolyte membrane 110 is slightly larger in size than the first catalyst layer 120A and the second catalyst layer 120B, and a peripheral portion of the electrolyte membrane 110 protrudes from the cathode catalyst layer 120A and the anode catalyst layer 120B. The peripheral portion of the electrolyte membrane 110 is held between a pair of seal members 250A and 250B.

One of the first catalyst layer 120A and the second catalyst layer 120B is an anode catalyst layer and the other is a cathode catalyst layer. Here, the first catalyst layer 120A is used as a cathode catalyst layer, and the second catalyst layer 120B is used as an anode catalyst layer. In this case, the first gas diffusion layer 130A corresponds to the cathode-side gas diffusion layer, and the second gas diffusion layer 130B corresponds to the anode-side gas diffusion layer.

FIG. 2 is a partially enlarged schematic diagram of the membrane-electrode assembly 100 of FIG. 1, showing inside of the first catalyst layer 120A and the first gas diffusion layer 130A constituting part of the membrane-electrode assembly 100. The first catalyst layer 120A contains a first particulate conductive member 121 and a first fibrous conductive member 122, as a conductive material. The first particulate conductive member 121 has catalyst particles supported thereon. The first gas diffusion layer 130A includes a second particulate conductive member 131 and a second fibrous conductive member 132, as a conductive material. In the first gas diffusion layer 130A, the content K₂ by mass of the second fibrous conductive member 132 to the total of the second fibrous conductive member 132 and the second particulate conductive member 131 is larger than the content K₁ by mass of the first fibrous conductive member 122 to the total of the first fibrous conductive member 122 and the first particulate conductive member 121, in the first catalyst layer 120A.

### (Gas Diffusion Layer)

The first gas diffusion layer 130A (cathode-side gas diffusion layer) and the second gas diffusion layer 130B (anode-side gas diffusion layer) may be either a structure having a substrate layer or a structure not having a substrate layer. More preferred is a structure not having a substrate layer. Examples of the structure not having a substrate layer include a microporous sheet formed from a conductive material and a polymer resin. Examples of the structure having a substrate layer include a structure body having a substrate layer and a microporous layer provided thereon on the catalyst layer side. The substrate layer may be an electrically conductive porous sheet, such as carbon cloth or carbon paper. The microporous layer may be, for example, a mixture of a water-repellent resin such as fluorocarbon resin, an electrically conductive carbon material, and a proton-conductive resin (polymer electrolyte).

The substrate-less gas diffusion layer contains, for example, a conductive material (second conductive material) and a polymer resin. The polymer resin that can be used is a water-repellent fluorocarbon resin or the like as described below. The polymer resin is preferably contained in an amount of 10 to 40 parts by mass per 100 parts by mass of the total of the polymer resin and the conductive material. The conductive material includes a fibrous conductive member (second fibrous conductive member). The conductive material may further include a particulate conductive member (second particulate conductive member).

The particulate conductive member and the fibrous conductive member may be materials as described below for the catalyst layer. For a higher water removal efficiency, the fibrous conductive member (second fibrous conductive member) used in a gas diffusion layer may be the same kind of material as the fibrous conductive member (first fibrous conductive member) used in the catalyst layer in contact with the gas diffusion layer. By making similar to each other the physical properties of the fibrous conductive members contained in the catalyst layer and the gas diffusion layer contacting thereto, the water removal efficiency can be improved.

The conductive material may include a particulate conductive member and a fibrous conductive member, and may further include a planar material. The planar material can be disposed in the gas diffusion layer so as to be oriented along a plane direction (a direction perpendicular to the thickness direction) of the gas diffusion layer. The planar material exhibits an effect of enhancing the gas diffusivity in the plane direction of the gas diffusion layer. The planar material is particulate when viewed macroscopically, which, however, is composed of planar particles when viewed microscopically. Specific examples of the planar material include flake graphite, a pulverized product of graphitized polyimide film, and graphene. Among them, a pulverized product of graphitized polyimide film and graphene are easy to orient in the plane direction of the gas diffusion layer, and therefore, are advantageous in forming a gas diffusion layer to be thin and suitable for enhancing the gas diffusivity in the plane direction of the gas diffusion layer.

In the first gas diffusion layer 130A and/or the second gas diffusion layer 130B, the content of the fibrous conductive member (second fibrous conductive member) in the conductive material (second conductive material) can be set so as to satisfy the Condition 1, in relation with the conductive material (first conductive material) contained in the catalyst layer disposed in contact with the gas diffusion layer. At least one of a combination of the first gas diffusion layer 130A (cathode-side gas diffusion layer) and the first catalyst layer 120A (cathode catalyst layer) and a combination of the second gas diffusion layer 130B (anode-side gas diffusion layer) and the second catalyst layer 120B (anode catalyst layer) may satisfy the Condition 1. In the example illustrated in FIG. 2, a combination of the first gas diffusion layer 130A and the first catalyst layer 120A satisfies the Condition 1. In view of facilitating removal of the water produced by power generation, thereby to prevent the gas diffusion paths from being blocked with the produced water, and to enhance the diffusivity of reaction gas to the catalyst layers, desirably, at least a combination of the first gas diffusion layer 130A (cathode-side gas diffusion layer) and the first catalyst layer 120A (cathode catalyst layer) satisfies the Condition 1.

The polymer resin has a function as a binder for binding the conductive materials to each other. In view of suppressing the accumulation of water in the pores of the gas diffusion layer, it is preferable that 50 mass % or more, or further, 90 mass % or more of the polymer resin is a fluorocarbon resin having water repellency. Examples of the fluorocarbon resin include PTFE (polytetrafluoroethylene), FEP (tetrafluoroethylene-hexafluoropropylene copolymer), PVdF (polyvinylidene fluoride), ETFE (tetrafluoroethylene-ethylene copolymer), PCTFE (polychlorotrifluoroethylene), and PFA (tetrafluoroethylene-perfluoroalkyl vinyl ether copolymer). In particular, the fluorocarbon resin is preferably PTFE, in terms of heat resistance, water repellency and chemical resistance.

The gas diffusion layer can be formed, for example, as follows.

First, a mixture containing a conductive material, a polymer resin, a surfactant, and a dispersion medium is prepared. A mixing apparatus that can be used is a kneader or a mixer. In this case, it is preferable to feed a conductive material, a surfactant, and a dispersion medium into the mixing apparatus, to disperse the conductive material uniformly in the dispersion medium, and then add a polymer resin thereto for further dispersion. The polymer resin is preferably fibrillated by applying a moderate shearing force thereto. Examples of the dispersion medium include water, alcohols, and glycols. Examples of the surfactant include polyoxyethylene alkyl ether and alkyl amine oxide.

Next, the resultant mixture is formed into a sheet by a molding method, such as extrusion molding. The resultant sheet may be further rolled. For the rolling, a roll press can be used. The roll pressing may be carried out under any conditions, but pressing at a line pressure of 0.001 ton/cm to 4 ton/cm can easily form a gas diffusion layer with high strength.

Next, the sheet is baked, to form a baked sheet from which the surfactant and the dispersion medium are removed. The baking temperature may be set such that the polymer resin will not deteriorate and the surfactant and the dispersion medium will decompose or volatilize. When PTFE is used as the polymer resin, the baking temperature is preferably 310 to 340° C. The baking atmosphere is an inert atmosphere, and is preferably an atmosphere of, for example, nitrogen or argon, or a reduced pressure atmosphere. Regarding the surfactant and the dispersion medium, it suffices when most of them are removed from the sheet, and they may not be necessarily completely removed.

### (Catalyst Layer)

The first catalyst layer 120A (cathode catalyst layer) contains, for example, a conductive material (first conductive material), catalyst particles, and a proton conductive resin. The catalyst particles are supported on the conductive material. The conductive material includes a particulate conductive member (first particulate conductive member). The conductive material may further include a fibrous conductive member (first fibrous conductive member). By including the fibrous conductive member, the gas diffusivity in the catalyst layer can be enhanced.

The second catalyst layer 120B (anode catalyst layer), like the first catalyst layer 120A (cathode catalyst layer), can contain a conductive material, catalyst particles supported on the conductive material, and a proton conductive resin. The conductive material includes a particulate conductive member, and can further include a fibrous conductive member.

When the conductive material includes both a particulate conductive member and a fibrous conductive member, desirably, the catalyst particles are supported on the particulate conductive member. The smaller the amount of the catalyst particles supported on the fibrous conductive member is, the higher the water repellency of the fibrous conductive member becomes. Therefore, the water removal tends to be improved, and the gas diffusivity tends to be enhanced. In view of improving the water removal, the catalyst particles may not be substantially supported on the fibrous conductive member. In other words, the catalyst particles may be supported only on the particulate conductive member. Here, that the catalyst particles are not substantially supported on the fibrous conductive member means that the ratio of the catalyst particles supported on the fibrous conductive member is 0.5 parts by mass or less per 100 parts by mass of the total of the catalyst particles supported on the fibrous conductive member and the fibrous conductive member.

In the first catalyst layer 120A and/or the second catalyst layer 120B, the content of the fibrous conductive member (first fibrous conductive member) in the conductive material (first conductive material) can be set so as to satisfy the Condition 1, in relation with the conductive material (second conductive material) contained in the gas diffusion layer disposed in contact with the catalyst layer.

The anode catalyst layer will not be exposed to an oxidizing environment so strong as that the cathode catalyst layer is exposed to. However, due to lack of the water produced by reaction, the anode catalyst layer tends to be in a less humidified environment than that the cathode catalyst layer is to be. As a result, the proton conductivity tends to be reduced. The composition and the content of each of the particulate conductive member, the fibrous conductive member, and the proton conductive resin may be varied, so that a higher proton conductivity than that of the cathode catalyst layer can be obtained.

### (Fibrous Conductive Member)

The fibrous conductive member may be, for example, a fibrous carbon material, such as vapor grown carbon fibers (VGCF (registered trademark)), carbon nanotubes, and carbon nanofibers. The diameter DF of the fibrous conductive member is not limited, but is preferably 200 nm or less, more preferably 5 nm or more and 200 nm or less, and more preferably 10 nm or more and 170 nm or less. In this case, the gas passage can be sufficiently secured while reducing the volume ratio of the fibrous conductive member in the catalyst layer, and the gas diffusivity can be enhanced. The diameter D_{F} of the fibrous conductive member can be determined by taking out 10 random fibers of the fibrous conductive member from the catalyst layer and averaging these diameters. The diameter is a length perpendicular to the longitudinal direction of the fibrous conductive member.

The length L_{F} of the fibrous conductive member (fiber length) is also not limited, but is preferably 0.2 μm or more and 20 μm or less, more preferably 0.2 μm or more and 10 μm or less. In this case, at least some fibers of the fibrous conductive member are oriented along the thickness direction of the catalyst layer, making it easy to ensure gas diffusion passage. The length L_{F} of the fibrous conductive member is an average fiber length, which can be determined by taking out 10 random fibers of the fibrous conductive member from the catalyst layer and averaging the fiber lengths of the fibrous conductive member. Here, the fiber length of the fibrous conductive member means, when the fibrous conductive member is substantially linear in shape, a length of a straight line connecting one end of the fibrous conductive member to the other end thereof.

The fibrous conductive member may have an empty space (hollow portion) in its inside. In this case, in the catalyst layer, the fibrous conductive member may be open at both ends in the longitudinal direction. Here, that the fibrous conductive member is open at both ends in the longitudinal direction means that the hollow portion is in communication with the outside via the open ends. In other words, the openings at both ends of the fibrous conductive member are not closed by the electrolyte membrane or the gas diffusion layer, and gas can enter and exit through the both ends.

The fibrous conductive member having the hollow portion may have a through-hole in its sidewall, for allowing communication between the hollow portion and the outside. The catalyst particles can be disposed and immobilized on the sidewall of the fibrous conductive member so as to close at least part of the through-hole. The catalyst particles disposed on the sidewall so as to close at least part of the through-hole can efficiently contact with the reaction gas, and thus, the reaction efficiency of the catalyst layer can be significantly improved.

### (Particulate Conductive Member)

The particulate conductive member is not limited. Examples thereof include carbon black, spherical graphite, activated carbon, and the like. In particular, carbon black is preferred because of its high conductivity and large pore volume. Examples of the carbon black include acetylene black, Ketjen black, thermal black, furnace black, and channel black. The particle diameter thereof (or the length of a structure composed of connected primary particles) is not limited, and any diameter of electrically conductive material as conventionally used for the catalyst layer of fuel cells may be adopted.

### (Catalyst Particles)

The catalyst particles are not limited, but may be a catalyst metal, such as an alloy or simple substance, including at least one kind of element selected from Sc, Y, Ti, Zr, V, Nb, Fe, Co, Ni, Ru, Rh, Pd, Pt, Os, Ir, lanthanoid series elements, and actinoid series elements. Examples of the catalyst particles used for the anode include Pt and a Pt—Ru alloy. Examples of the catalyst particles used for the cathode include Pt and a Pt—Co alloy. At least part of the catalyst particles are supported on the particulate conductive member. The catalyst particles may be supported on a specific conductive member on which their contact with gas can be ensured. This allows the catalyst particles to be more likely to come into contact with gas, resulting in an enhanced efficiency of the oxidation or reduction reaction of the gas.

In view of immobilizing the catalyst particles, the catalyst particles preferably have a diameter X of 1 nm or more and 10 nm or less, more preferably 2 nm or more and 5 nm or less. When the X is 1 nm or more, the catalyst particles can sufficiently exert their catalytic effect. When the X is 10 nm or less, the catalyst particles can be easily supported on the sidewall of the fibrous conductive member.

The diameter X of the catalyst particles can be determined as follows.

With respect to one catalyst particle observed in a TEM image of the catalyst layer, assuming that the particle is spherical, the diameter of the particle is measured. In this way, with respect to 100 to 300 catalyst particles observed on the TEM image, the diameter of each particle is measured. An average of the particle diameters is calculated as the diameter X of the catalyst particles.

### (Proton Conductive Resin)

The proton conductive resin is not limited. Examples thereof include a perfluorocarbon sulfonic acid-series polymer and a hydrocarbon-based polymer. Preferred is a perfluorocarbon sulfonic acid-series polymer because of its excellent heat resistance and chemical stability. The perfluorocarbon sulfonic acid-series polymer is exemplified by Nafion (registered trademark). The proton conductive resin covers at least part of the particulate conductive member, the fibrous conductive member, and/or the catalyst particles.

The proton conductive resin is preferably contained in an amount of 25 to 65 parts by mass per 100 parts by mass of the total of the proton conductive resin and the conductive material.

The thickness of the catalyst layer is desirably as small as possible, in view of reducing the size of the fuel cell, and maintaining the proton resistance low, thereby to achieve a high output power. On the other hand, in view of the strength, the thickness is preferably not too small. Typically, increasing the blending ratio of the fibrous conductive member tends to increase the thickness of the catalyst layer.

The thickness T_{C} of the cathode catalyst layer is, for example, 4 μm or more and 15 μm or less. The thickness T_{A} of the anode catalyst layer is, for example, 2 μm or more and 12 μm or less. The thicknesses T_{C} and T_{A} of the catalyst layer are each an average thickness, which can be determined by averaging the lengths of straight lines drawn from one principal surface to the other principal surface along the thickness direction of the catalyst layer at 10 random points in a cross section of the catalyst layer.

Regarding the blending ratio of the fibrous conductive member in the catalyst layer, when the fibrous conductive member is contained in an amount of 20% or more by mass relative to the particulate conductive member both in the anode catalyst layer and the cathode catalyst layer, the gas diffusivity can be enhanced. However, increasing the blending amount of the fibrous conductive member tends to result in an increased film thickness of the catalyst layer, and the proton migration resistance tends to increase. Moreover, cracks tend to occur in the catalyst layer. In view of suppressing the increase in proton migration resistance and suppressing the occurrence of cracks, the blending amount of the fibrous conductive member may be 50% or less by mass relative to the particulate conductive member, in the cathode catalyst layer and/or the anode catalyst layer.

The catalyst layer is prepared, for example, as follows.

First, catalyst particles and a particulate conductive member are mixed in a dispersion medium (e.g., water, ethanol, propanol). Next, to the resultant dispersion under stirring, a proton conductive resin and a fibrous carbon material are sequentially added, to obtain a catalyst dispersion. The proton conductive resin may be added dividedly in two or more times. In this case, in the second and subsequent addition, the proton conductive resin may be added together with the fibrous carbon material. Thereafter, the resultant catalyst dispersion is applied onto a surface of the electrolyte membrane or an appropriate transfer base sheet in a uniform thickness, followed by drying. A catalyst layer is thus obtained.

The application can be performed by a conventional application method, for example, spraying, screen printing, and coating using various coaters, such as a blade coater, a knife coater, and a gravure coater. The transfer base sheet is preferably a sheet with smooth surface, such as polyethylene terephthalate (PET) or polypropylene. When a transfer base sheet is used, the obtained catalyst layer is transferred onto an electrolyte film or a gas diffusion layer as described below.

The transfer of the catalyst layer onto the electrolyte membrane or the gas diffusion layer is made by bringing a surface of the catalyst layer, the surface having faced the transfer base sheet, into contact with the electrolyte membrane or the gas diffusion layer. By bringing the smooth surface of the catalyst layer into contact with the electrolyte membrane or the gas diffusion layer, the interface resistance with the catalyst layer is reduced, leading to improved performance of the fuel cell. The catalyst dispersion may be applied directly onto the electrolyte layer.

### (Electrolyte Membrane)

The electrolyte membrane 110 is preferably a polymer electrolyte membrane. Examples of the material of the polymer electrolyte membrane include polymer electrolytes exemplified as the proton-conductive resin. The electrolyte membrane has a thickness of, for example, 5 to 30 μm.

### (Separator)

The first separator 240A and the second separator 240B, as long as having airtightness, electron conductivity, and electrochemical stability, may be made of any material. Preferable examples of such materials include a carbon material and a metal material. The metal material may be coated with carbon. The first separator 240A and the second separator 240B can be obtained by, for example, punching a metal sheet into a predetermined shape, and applying surface treatment thereto.

In the present embodiment, the first separator 240A is provided with a gas flow channel 260A, on a surface in contact with the first gas diffusion layer 130A. The second separator 240B is provided with a gas flow channel 260B, on a surface in contact with the second gas diffusion layer 130B. The gas flow channel may be of any shape, and can be formed in a shape of, for example, straight shape, or serpentine shape.

### (Seal Member)

The seal members 250A and 250B are a material having elasticity, and prevent the leakage of fuel and/or oxidant from the gas flow channels 260A and 260B. For example, the seal members 250A and 250B each have a frame-like shape continuously surrounding the peripheral edge portion of the first and second catalyst layers 120A and 120B. Any known material and any known configuration can be employed for the seal members 250A and 250B.

The present disclosure will be more specifically described below with reference to Examples. It is to be noted, however, that the present disclosure is not limited to the following Examples.

### EXAMPLES

### (1) Preparation of Dispersion for Cathode Catalyst Layer

A particulate conductive member (carbon black) supporting catalyst particles (Pt—Co alloy) was added to an appropriate amount of water, and stirred and dispersed. To the resultant dispersion under stirring, an appropriate amount of ethanol was added. Then, per 100 parts by mass of the above particulate conductive member supporting catalyst particles, 35 parts by mass of a fibrous conductive member (first fibrous conductive member) (vapor-grown carbon fiber, average diameter: 150 nm, average fiber length: 10 μm) and 100 parts by mass of a proton conductive resin (perfluorocarbon sulfonic acid-series polymer) were added, and stirred together, to prepare a catalyst dispersion for a cathode catalyst layer.

### (2) Preparation of Dispersion for Anode Catalyst Layer

A particulate conductive member (carbon black) supporting catalyst particles (Pt) was added to an appropriate amount of water, and stirred and dispersed. To the resultant dispersion under stirring, an appropriate amount of ethanol was added. Then, per 100 parts by mass of the above particulate conductive member supporting catalyst particles, 35 parts by mass of a fibrous conductive member (first fibrous conductive member) (vapor-grown carbon fiber, average diameter: 150 nm, average fiber length: 10 μm) and 120 parts by mass of a proton conductive resin (perfluorocarbon sulfonic acid-series polymer) were added, and stirred together, to prepare a catalyst dispersion for an anode catalyst layer.

### (3) Formation of Gas Diffusion Layer

A particulate conductive member (carbon black), a fibrous conductive member (vapor-grown carbon fiber, average diameter: 150 nm, average fiber length: 10 μm), a surfactant, and a dispersion medium were fed into a stirrer, and stirred and kneaded, to uniformly disperse the materials. Thereafter, PTFE was further fed as a polymer resin, and uniformly dispersed, to obtain a kneaded material. The kneaded material was then extruded and stretched into a sheet, and dried. The resultant sheet was baked at 310° C. to remove the surfactant and the dispersion medium therefrom. A gas diffusion layer was thus obtained.

The contents of the particulate conductive material, the fibrous conductive material, and the polymer resin in the gas diffusion layer were adjusted in a range of 5 mass % to 35 mass % for the particulate conductive material, 35 mass % to 80 mass % for the fibrous conductive material, and 10 mass % to 40 mass % for the polymer resin. In this way, four kinds of gas diffusion layers A1 to A3 and B1 differing in the content K₂ by mass of the fibrous conductive member in the conductive material were formed.

In the gas diffusion layers A1, A2, A3 and B1, the content K₂ by mass of the fibrous conductive member in the conductive material was set to 0.88, 0.86, 0.71 and 0.26, respectively.

### (4) Fabrication of Unit Cell

Two PET sheets were prepared. The catalyst dispersion for a cathode catalyst layer and the catalyst dispersion for an anode catalyst layer were uniformly applied by screen printing onto a smooth surface of one PET sheet and onto a smooth surface of the other PET sheet, respectively. This was followed by drying, to form two catalyst layers. The cathode catalyst layer had a thickness of 6 μm, and the anode catalyst layer had a thickness of 4.5 μm.

The resultant catalyst layers were transferred onto both principal surfaces of a 15-μm-thick electrolyte membrane, one by one, to form a cathode on one surface of the electrolyte membrane and an anode on the other surface. Subsequently, two sheets of gas diffusion layers were prepared. One of the two was brought into contact with the anode and the other was brought into contact with the cathode, to form a membrane-electrode assembly. In the membrane-electrode assembly, the content K₁ by mass of the fibrous conductive member in the conductive material in each of the cathode catalyst layer and the anode catalyst layer was set to 0.26.

Next, a frame-shaped seal member was placed so as to surround the anode and cathode. The whole was sandwiched with a pair of stainless steel flat plates (separators) each having a gas flow channel at a place where the plate comes in contact with the gas diffusion layer, to complete a test unit cell. p

In this way, test unit cells X1, X2, X3 and Y1 were fabricated using the gas diffusion layers A1, A2, A3 and B1, respectively, and each evaluated for its performance.

### <Evaluation>

The unit cell was heated to 80° C. A fuel gas having a relative humidity of 100% was supplied to the anode, and an oxidant gas (air) having a relative humidity of 100% was supplied to the cathode. The fuel gas and the oxidant gas were pressurized and fed such that the gas pressure at the cell inlet was 40 to 120 kPa, depending on the current density. Then, with the current flow kept at a constant rate using a load controller, voltage V (initial voltage) of the unit cell was measured. The voltages were measured while varying the current density per electrode area of the anode and the cathode.

With respect to each of the unit cells X1 to X3 and Y1, the maximum output density Wₘₐₓ was evaluated. The evaluation results are shown in Table 1. For the maximum output density Wₘₐₓ, Table 1 shows a value relative to the maximum output density Wₘₐₓ of the unit cell Y1, which is taken as 100. In the cells X1 to X3 in which the content K₂ of the fibrous conductive member in the conductive material in the gas diffusion layer was set larger than the content K₁ of the fibrous conductive member in the conductive material in the catalyst layer, the maximum output density was improved as compared to the cell Y1 in which the K₂ was set the same as the K₁.

TABLE 1

| | | Maximum output density |
|---|---|---|
| Cell | Gas diffusion layer | Wₘₐₓ |
| X1 | A1 | 144 |
| X2 | A2 | 152 |
| X3 | A3 | 147 |
| Y1 | B1 | 100 |

### Industrial Applicability

The fuel cell according to the present disclosure can be suitably used, for example, as a stationary power supply for a household cogeneration system, and a vehicle power supply. The present invention can be suitably applied to a polymer electrolyte fuel cell, but is not limited thereto, and can be applied to fuel cells in general.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE SIGNS LIST

100: membrane-electrode assembly, 110: electrolyte membrane, 120A: first catalyst layer, 120B: second catalyst layer, 130 A: first gas diffusion layer, 130B: second gas diffusion layer, 200: fuel cell (unit cell), 240A: first separator, 240B: second separator, 250A, 250B: seal member, 260A, 260B: gas flow channel

1-11. (canceled)

12. A membrane-electrode assembly for a fuel cell, the membrane-electrode assembly comprising:
an electrolyte membrane;
a pair of catalyst layers stacked respectively on one and the other surfaces of the electrolyte membrane; and
a pair of gas diffusion layers stacked respectively on a side opposite to the electrolyte membrane of one of the pair of catalyst layers and on a side opposite to the electrolyte membrane of the other one of the pair of catalyst layers, wherein
one of the pair of catalyst layers contains catalyst particles A and a first conductive material,
one of the pair of gas diffusion layers which is in contact with the one of the catalyst layers contains a second conductive material,
the first conductive material includes a first particulate conductive member and a first fibrous conductive member,
the second conductive material includes at least a second fibrous conductive member, and
a content K2 by mass of the second fibrous conductive member in the second conductive material is larger than a content K1 by mass of the first fibrous conductive member in the first conductive material.

13. The membrane-electrode assembly according to claim 12, wherein a ratio of a fiber length of the second fibrous conductive member to a fiber length of the first fibrous conductive member is in a range of 0.5 to 2.0.

14. The membrane-electrode assembly according to claim 12, wherein a ratio of a fiber diameter of the second fibrous conductive member to a fiber diameter of the first fibrous conductive member is in a range of 0.5 to 2.0.

15. The membrane-electrode assembly according to claim 12, wherein the first fibrous conductive member and the second fibrous conductive member include a same kind of material.

16. The membrane-electrode assembly according to claim 12, wherein the content K2 of the second fibrous conductive member in the second conductive material is 60 mass % or more.

17. The membrane-electrode assembly according to claim 12, wherein the one of the catalyst layers constitutes a cathode of the fuel cell.

18. The membrane-electrode assembly according to claim 17, wherein
the other one of the pair of catalyst layers contains catalyst particles B and a third conductive material, and
the third conductive material includes a third particulate conductive member and a third fibrous conductive member.

19. The membrane-electrode assembly according to claim 18, wherein a ratio K3/K1 of a content K3 by mass of the third fibrous conductive member in the third conductive material to the content K1 is in a range of 0.5≤K3/K1≤2.0.

20. The membrane-electrode assembly according to claim 18, wherein the content K2 is larger than a content K3 by mass of the third fibrous conductive member in the third conductive material.

21. The membrane-electrode assembly according to claim 18, wherein
the gas diffusion layer in contact with the other catalyst layer contains a fourth conductive material,
the fourth conductive material includes at least a fourth fibrous conductive member, and
a content K4 by mass of the fourth fibrous conductive member in the fourth conductive material is larger than a content K3 by mass of the third fibrous conductive member in the third conductive material.

22. The membrane-electrode assembly according to claim 18, wherein
the gas diffusion layer in contact with the other catalyst layer contains a fourth conductive material, and
the fourth conductive material does not include a fourth fibrous conductive member, or a content K4 by mass of the fourth fibrous conductive member in the fourth conductive material is smaller than the content K2.

23. A fuel cell, comprising the membrane-electrode assembly of claim 12.
